(19) United States
(12) Patent Application Publication
(10) Pub. No.: US 2008/0138524 A1
(43) Pub. Date: Jun. 12, 2008

(54) MANUFACTURING METHOD FOR PERPENDICULAR MAGNETIC RECORDING MEDIUM

(75) Inventors: Tadaaki Oikawa, Kai City (JP); Hiroyuki Uwazumi, Minami-Alps City (JP); Kenichiro Soma, Minami-Alps City (JP); Hajime Kurihara, Minami-Alps City (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD, Tokyo (JP)

(21) Appl. No.: 11/763,789

(22) Filed: Jun. 15, 2007

(30) Foreign Application Priority Data
Dec. 6, 2006 (JP) 2006-329413

(51) Int. Cl. B05D 3/04

(52) U.S. Cl. 427/331

(57) ABSTRACT

A manufacturing method for a magnetic recording medium is disclosed. By using the method, the anisotropic magnetic field (Hk) of an underlayer is improved, spike noise generated in the soft magnetic underlayer is suppressed, and the signal-to-noise ratio (SNR) is improved without employing a special layer configuration and without the need for complicated and expensive processing. A soft magnetic underlayer is formed by laminating a soft magnetic lower underlayer, a non-magnetic metal layer, and a soft magnetic upper underlayer in succession on a non-magnetic substrate. After forming the non-magnetic metal layer, its surface is exposed to a gas containing between 2 and 100 at % oxygen. A perpendicular magnetic recording layer is formed on the soft magnetic underlayer.

### CROSS REFERENCE TO RELATED APPLICATIONS

This application claims priority from Japanese application Serial No. JP 2006-329413, filed on Dec. 6, 2006, the contents of which are incorporated herein by reference in their entirety.

### BACKGROUND OF THE INVENTION

A. Field of the Invention

The present invention relates to a manufacturing method for a perpendicular magnetic recording medium for installation in various types of magnetic disk apparatus, and more particularly to a manufacturing method for obtaining a high quality magnetic recording medium without employing a special layer configuration and without the need for complicated, expensive processing.

B. Description of the Related Art

Longitudinal magnetic recording, in which magnetization information is recorded and reproduced in a parallel direction to a medium substrate surface and along the traveling direction of a recording head, is known as an example of a magnetic recording method.

In recent years, accompanying demand for increased capacity in magnetic recording and reproduction apparatuses, demands have been made for improvements in the recording density of magnetic recording media. However, when the recording density is improved, the surface area of the medium occupied by a single recording bit decreases. As a result, a thermal demagnetization phenomenon, whereby the magnetization state on the magnetic recording layer of the medium becomes thermally unstable, occurs to a noticeable degree.

Hence, perpendicular magnetic recording, which is a magnetic recording method in which thermal demagnetization is comparatively unlikely to occur, has been proposed as an alternative to longitudinal magnetic recording. By employing a perpendicular magnetic recording method, the recording density can be set at approximately 100 to 200 Gb/in².

Typically, a perpendicular magnetic recording medium is a laminated body formed by laminating at least an underlayer formed from a soft magnetic material and a magnetic recording layer formed from a hard magnetic material on a substrate. The magnetic recording layer is used to record information by means of a magnetic field generated through use of a magnetic head. The underlayer serves to concentrate the magnetic field generated from the magnetic head, or in other words to obtain a head magnetic field having a sharp gradient in the perpendicular direction, which is required for perpendicular recording. This improves the recording resolution and increases the reproduction output.

In a perpendicular magnetic recording medium having the structure described above, a domain wall is formed in the underlayer made of the soft magnetic material, and as a result of this domain wall, spike noise occurs. The specific mechanisms for the generation of spike noise are as follows.

Since the underlayer formed on the substrate is made of a soft magnetic material, its anisotropy is low. Therefore, a closure domain is generated in order to reduce the magnetostatic energy on the inner and outer peripheral end portions of the underlayer. When the closure domain is generated, the domain wall, which appears as a boundary between regions having aligned magnetization directions, takes a Bloch form, in which spin rotates in a perpendicular direction to the film thickness surface, in an underlayer having an adequate film thickness for practical application. As a result, perpendicular direction poles appear at the upper and lower ends of the domain wall on the basis of the rotational behavior of the spin, a perpendicular direction leakage magnetic field generated at the poles acts on the reproducing head, and thus, spike noise occurs.

In order to reduce noise in a perpendicular magnetic recording medium, the formation of a domain wall on the inner and outer peripheral end portions of the underlayer must be suppressed. The following techniques have been disclosed as methods for controlling the formation of a domain wall in an underlayer formed from a soft magnetic material.

Japanese Unexamined Patent Application Publication H1-128226 discloses a perpendicular magnetic recording medium in which a soft magnetic layer and a hard magnetic layer as a ground are formed on a base, and the soft magnetic layer is a multi-layer film form comprising two or more layers.

Japanese Unexamined Patent Application Publication H7-85442 discloses a perpendicular magnetic recording medium comprising a non-magnetic substrate with a soft magnetic underlayer and a perpendicular magnetization recording layer provided thereon. The soft magnetic underlayer is formed using a CoB film, and this film is separated into at least two layers by a non-magnetic film.

In the techniques disclosed in Japanese Unexamined Patent Application Publication H1-128226 and Japanese Unexamined Patent Application Publication H7-85442, when forming the underlayer on a disk-shaped substrate, the underlayer is structured such that a non-magnetic metal layer is sandwiched between a plurality of soft magnetic films, and the magnetization directions of the soft magnetic films forming the main part of the underlayer are coupled antiferromagnetically so as to be oriented 180° from each other. Further, during sputtering, the magnetic field of a rotated magnetron is used. As a result, the magnetization directions are aligned in the radial direction of the substrate, and the generation of a domain wall that causes spike noise is suppressed.

Note that when the underlayer has a sandwich structure in which a non-magnetic metal layer is sandwiched between upper and lower soft magnetic films, an exchange coupling magnetic field that may be considered an index of the coupling force of the two soft magnetic films is generated therebetween. The exchange coupling magnetic field attenuates steadily as the film thickness of the non-magnetic metal layer increases, while the film thickness of the non-magnetic metal layer at which the antiferromagnetic coupling force of the exchange coupling magnetic field reaches a maximum depends on the electronic structure and crystalline orientation of the non-magnetic metal layer used. Hence, by modifying the design of these elements appropriately, the exchange coupling magnetic field can be increased, enabling further suppression of spike noise and improvement in the quality of the magnetic recording medium.

Strong demands have been made in recent years for improvements in the signal-to-noise ratio (to be abbreviated to “SNR” hereafter) through the suppression of spike noise generated in the soft magnetic underlayer, to further improve the quality of a perpendicular magnetic recording medium having this type of sandwich structure underlayer. These improvements are vital for increased density.

An increase the anisotropic magnetic field (to be referred to simple as “Hk” hereafter), which is a parameter for evaluating the characteristics of the underlayer, is an effective means for suppressing spike noise generated in the soft magnetic underlayer, or in other words means for improving the SNR. The Hk is determined by the saturation magnetization (Ms) and the film thickness of the soft magnetic films, the coupling force between the soft magnetic films, which is dependent on the film thickness of the non-magnetic metal layer, and so on, and also depends on the formation process and the layer configuration. The SNR is also dependent on spike noise, which is suppressed by increasing the Hk, i.e., increasing the exchange coupling magnetic field.

A method of using antiferromagnetic thin films as the soft magnetic films serving as the upper and lower layers of the underlayer and using exchange coupling to pin the magnetizations thereof is known as a method of increasing the Hk by focusing on the layer configuration. However, to obtain a sufficiently large Hk, heat treatment must be implemented for several minutes to several hours following deposition of the underlayer. A method of obtaining the underlayer by laminating together numerous soft magnetic layers and antiferromagnetic layers is known as another method of increasing the Hk by focusing on the layer configuration. However, when a plurality of layers is formed in this manner, a complicated and expensive manufacturing method must be employed, and this poses a problem in terms of productivity.

The present invention is directed to overcoming or at least reducing the effects of one or more of the problems set forth above.

### SUMMARY OF THE INVENTION

An object of the present invention is to solve the problems described above by providing a manufacturing method for a magnetic recording medium in which the signal-to-noise ratio (SNR) of the magnetic recording medium is improved by increasing the anisotropic magnetic field (Hk) of an underlayer. By increasing the exchange coupling magnetic field, spike noise generated in the soft magnetic underlayer is suppressed without employing a special layer configuration and without the need for complicated, expensive processing.

The present invention relates to a manufacturing method for a magnetic recording medium comprising the steps of forming a soft magnetic underlayer by laminating a soft magnetic lower underlayer, a non-magnetic metal layer, and a soft magnetic upper underlayer in succession on a non-magnetic substrate, and forming a perpendicular magnetic recording layer on the soft magnetic underlayer. After forming the non-magnetic metal layer, a surface thereof is exposed to a gas containing between 2 and 100 at % oxygen. In the manufacturing method for a magnetic recording medium according to the present invention, the anisotropic magnetic field (Hk) of the soft magnetic underlayer is improved without employing a special layer configuration and without the need for complicated and expensive processing, and as a result, the SNR of the magnetic recording medium is improved. In this manufacturing method, the film thickness of the soft magnetic lower underlayer is preferably between 10 and 500 nm, the film thickness of the non-magnetic metal layer is preferably between 0.1 and 5 nm, and the film thickness of the soft magnetic upper underlayer is preferably between 10 and 500 nm. Further, in this manufacturing method, the non-magnetic metal layer is preferably formed from an element selected from Cu, Ru, Rh, Pd, and Re, or an alloy containing these elements, or a material having these elements or an alloy thereof as a main constituent. Further, the manufacturing method may further comprise a step of forming a non-magnetic intermediate layer on the soft magnetic underlayer, and/or a step of forming a protective layer on the perpendicular magnetic recording layer.

The manufacturing method for a magnetic recording medium according to the present invention employs a sandwich structure in which the non-magnetic metal layer is sandwiched between soft magnetic films, and therefore the formation of a domain wall in the underlayer in relation to a large external magnetic field can be suppressed, whereby spike noise can be suppressed. Spike noise suppression and improvement in the SNR can be realized without employing a special layer configuration and without the need for complicated and expensive processing. Accordingly, with the present invention, a magnetic recording medium having a far higher quality than those of the related art can be obtained by a simple and inexpensive method.

### BRIEF DESCRIPTION OF THE DRAWINGS

The foregoing advantages and features of the invention will become apparent upon reference to the following detailed description and the accompanying drawings, of which:

FIG. 1 is a sectional view showing an example of a perpendicular magnetic recording medium obtained by a manufacturing method of the present invention;

FIG. 2 is a sectional view showing in sequence each process of the manufacturing method for a magnetic recording medium according to the present invention;

FIG. 3 is a graph showing results obtained when a hysteresis loop of a laminated body according to a first example in a hard magnetization axis direction (radial direction) thereof was measured using a vibration sample magnetometer (VSM); and

FIG. 4 is a graph showing results obtained when a hysteresis loop of a laminated body according to a first comparative example in the hard magnetization axis direction (radial direction) thereof was measured using a vibration sample magnetometer (VSM).

### DETAILED DESCRIPTION OF SPECIFIC EMBODIMENTS

An embodiment of the present invention will be described in detail below with reference to the drawings.

### Magnetic Recording Medium

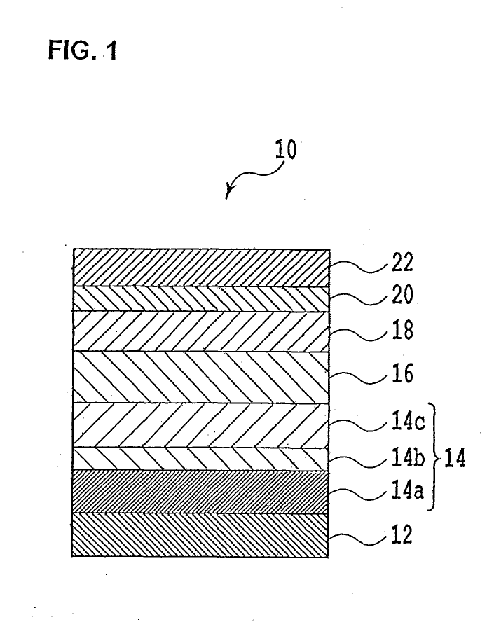

FIG. 1 is a sectional view showing an example of a perpendicular magnetic recording medium obtained by the manufacturing method of the present invention. Perpendicular magnetic recording medium 10 shown in the drawing is a laminated body formed by laminating soft magnetic underlayer 14, non-magnetic intermediate layer 16, perpendicular magnetic recording layer 18, protective layer 20, and liquid lubrication layer 22 in succession on non-magnetic substrate 12.

Non-magnetic substrate 12 may employ various types of glass substrate such as a reinforced glass substrate or a crystallized glass substrate, a metal substrate such as a NiP-plated aluminum substrate, a silicon substrate, a plastic substrate, and so on. Note that the thickness of substrate 12 is preferably set between 0.1 and 2 mm to prevent the moment of inertia from becoming excessively large while securing sufficient rigidity.

Soft magnetic underlayer 14 includes soft magnetic lower underlayer 14a, non-magnetic metal layer 14b, and soft magnetic upper underlayer 14c that are formed in succession. Soft magnetic lower underlayer 14a and soft magnetic upper underlayer 14c may be formed using a crystalline NiFe alloy, a sendust (FeSiAl) alloy, or a non-crystalline Co alloy such as CoZrNb. Meanwhile, non-magnetic metal layer 14b is preferably formed from an element selected from Cu, Ru, Rh, Pd, and Re, or an alloy containing these elements, or a material having these elements or an alloy thereof as a main constituent. A particularly favorable exchange coupling magnetic field is obtained when Ru is used, and therefore Ru is preferable.

When non-magnetic metal layer 14b is sandwiched between soft magnetic lower underlayer 14a and soft magnetic upper underlayer 14c in this manner, the easy magnetization axes of soft magnetic lower underlayer 14a and soft magnetic upper underlayer 14c can be oriented parallel to the surface of non-magnetic substrate 12 and 180° from each other. According to this orientation condition, the magnetizations of the two layers 14a, 14c sandwiching non-magnetic metal layer 14b are oppositely oriented and antiferromagnetically coupled, and therefore the orientation of the magnetizations does not vary even when external magnetization equal to or lower than the coupling strength thereof is applied. Hence, a domain wall is not generated throughout the entire soft magnetic layer 14, and spike noise generation can be suppressed.

The preferred film thickness of each layer 14a to 14c of soft magnetic underlayer 14 is as follows. An optimum value for the film thickness of soft magnetic lower underlayer 14a and soft magnetic upper underlayer 14c varies according to the structure and characteristics of the recording head, but a range of 10 to 500 nm is preferable in terms of improving productivity.

The film thickness of non-magnetic metal layer 14b must be selected appropriately such that the magnetizations of soft magnetic lower underlayer 14a and soft magnetic upper underlayer 14c are parallel to the surface of non-magnetic substrate 12, oriented in 180° opposing directions, and coupled with a high degree of strength. In consideration of these points, the film thickness of non-magnetic metal layer 14b is preferably set between 0.1 and 5 nm for the following reasons.

As the film thickness of non-magnetic metal layer 14b increases gradually from 0 nm, a coupling whereby the easy magnetization axes of soft magnetic lower underlayer 14a and soft magnetic upper underlayer 14c are parallel to the surface of non-magnetic substrate 12 and oriented in the same direction (ferromagnetic coupling) and a coupling whereby the easy magnetization axes are parallel to the surface of non-magnetic substrate 12 and oriented in 180° opposing directions (antiferromagnetic coupling) appear alternately. For example, when Ru is used as non-magnetic metal layer 14b, soft magnetic lower underlayer 14a and soft magnetic upper underlayer 14c are coupled ferromagnetically in an Ru film thickness range of 0 nm to approximately 0.3 nm, antiferromagnetically in a range of approximately 0.3 nm to approximately 1.2 nm, ferromagnetically in a range of approximately 1.2 nm to approximately 1.8 nm, and antiferromagnetically in a range of approximately 1.8 nm to approximately 3.0 nm. Thus, as the film thickness of non-magnetic metal layer 14b increases, ferromagnetic coupling and antiferromagnetic coupling occur cyclically, and therefore, by selecting an appropriate film thickness, soft magnetic lower underlayer 14a and soft magnetic upper underlayer 14c can be coupled antiferromagnetically. However, the coupling strength thereof decreases as the film thickness of non-magnetic metal layer 14b increases. As the coupling strength increases, external magnetic field resistance increases, and therefore the film thickness must be made as small as possible to obtain a high level of external magnetic field resistance. In consideration of these points, the upper limit value of the film thickness of non-magnetic metal layer 14b is preferably set at 5 nm.

The appropriate film thickness of non-magnetic metal layer 14b is dependent on the material used for non-magnetic metal layer 14b. In order to secure sufficient resistance to a floating magnetic field in a hard disk drive, the film thickness must be set to at least 0.1 nm. In consideration of this point, the lower limit value of the film thickness of non-magnetic metal layer 14b is preferably set at 0.1 nm.

Non-magnetic intermediate layer 16 serves to control the crystalline orientation and grain size of magnetic recording layer 18, to be described below, to favorable levels. For this purpose, it is vitally important to select an element and film thickness for non-magnetic intermediate layer 16 that are suited to the element group and crystal structure of perpendicular magnetic recording layer 18. For example, when magnetic recording layer 18 is a hexagonal CoCr-based layer, the recording layer is grown epitaxially from the intermediate layer, and therefore a metal having an identical hexagonal system, such as Ru, Re, and Os, or an alloy thereof, is preferably used. Note that the thickness of non-magnetic intermediate layer 16 is preferably set between 5 and 50 nm in consideration of the electromagnetic conversion characteristics, in particular the balance between SNR and metal elution.

There are no particular limits on perpendicular magnetic recording layer 18 as long as it is a film possessing magnetic anisotropy in a perpendicular direction to non-magnetic substrate 12. However, a CoPt-based alloy is preferably used. The addition of Cr, Ni, Ta, and so on to the CoPt alloy is particularly preferable for reducing medium noise, or in other words improving the SNR.

Note that when a Co alloy-based material having a hexagonal close-packed structure is used as perpendicular magnetic recording layer 18, the easy axis of magnetization is the C axis, and therefore the C axis of the structure must be oriented in a perpendicular direction to the layer surface. Further, the thickness of perpendicular magnetic recording layer 18 is preferably set between 2 and 30 nm in consideration of the electromagnetic conversion characteristics, in particular the balance between SNR and the overwrite characteristic.

Protective layer 20 serves to prevent damage to perpendicular magnetic recording layer 18 during reproduction of the recording medium by the recording and reproduction head and so on, and may be constituted by a protective film having carbon as a main constituent, for example. A DLC (Diamond Like Carbon) film formed by CVD (Chemical Vapor Deposition) is preferable from among such protective films in terms of head flotation and environmental resistance. Note that when protective layer 20 and/or liquid lubricant 22 are used, the laminated body is preferably partially compressed following the formation or application thereof to improve head flotation.

In the perpendicular magnetic recording medium obtained by the manufacturing method of the present invention, including the constitutional elements described above, the signal-to-noise ratio (SNR) of the magnetic recording medium is improved by increasing the anisotropic magnetic field (Hk) of the soft magnetic underlayer, or in other words the exchange coupling magnetic field, without employing a special layer configuration and without the need for complicated and expensive processing, as is described in the following manufacturing method section. Hence, the recording medium shown in FIG. 1 is of far higher quality than those of the related art.

### Manufacturing Method for Magnetic Recording Medium

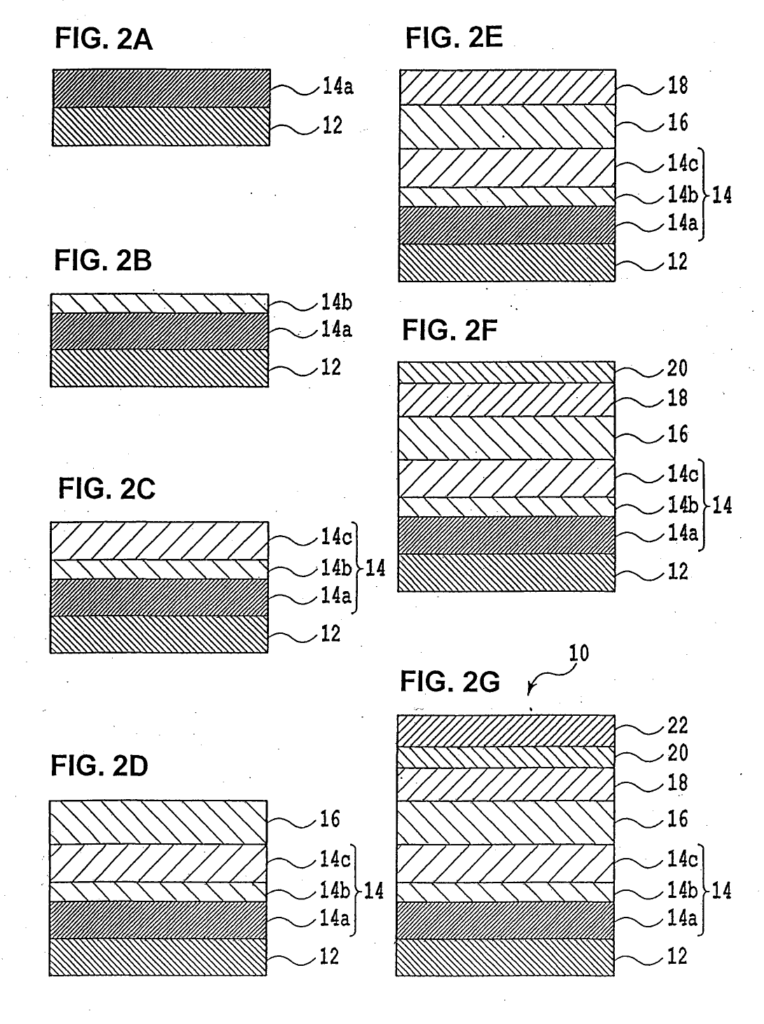

FIG. 2 is a sectional view showing in sequence each process of the manufacturing method for a magnetic recording medium according to the present invention.

Soft Magnetic Underlayer Formation Process

In the manufacturing method of the present invention, as shown in FIGS. 2A to 2C, first soft magnetic underlayer 14 is formed on non-magnetic substrate 12. To form soft magnetic underlayer 14, soft magnetic lower underlayer 14a, non-magnetic metal layer 14b, and soft magnetic upper underlayer 14c are formed in sequence in accordance with the drawings.

First, soft magnetic lower underlayer 14a is laminated onto non-magnetic substrate 12. The lamination process may employ various deposition methods such as DC magnetron sputtering, RF magnetron sputtering, and vacuum deposition, for example. In consideration of evenness and deposition speed, magnetron sputtering is particularly preferable. When magnetron sputtering is used, direct current discharge is preferable as the sputtering condition due to its controllability, and the sputtering pressure is preferably set low to increase the film density. By setting the sputtering pressure at no more than 5 mTorr, for example, deterioration of the environmental resistance (Co corrosion) due to Co precipitation on the medium surface can be suppressed.

Next, as shown in FIG. 2B, non-magnetic metal layer 14b is laminated on soft magnetic lower underlayer 14a. The lamination process may employ various deposition methods such as DC magnetron sputtering, RF magnetron sputtering, and vacuum deposition, for example. In consideration of evenness and deposition speed, magnetron sputtering is particularly preferable. When magnetron sputtering is used, direct current discharge is preferable as the sputtering condition due to its controllability, and the sputtering pressure is preferably set high to reduce the film density.

Further, the surface of non-magnetic metal layer 14b laminated in this manner is exposed to a gas containing oxygen. There are no particular limitations on the size and volume of the deposition chamber in which this exposure process is performed, and a deposition chamber belonging to a sputtering apparatus, a dedicated processing chamber capable of providing a vacuum state for the sole purpose of exposure to oxygen gas, and so on, for example, may be used. A mass flow controller belonging to a sputtering apparatus is preferable since the gas flow can be controlled accurately.

To maximize improvement in the anisotropic magnetic field (Hk) of soft magnetic underlayer 14 in particular, the gas exposure process must be performed evenly on the upper surface of the laminated body comprising layers 12, 14a, and 14b shown in FIG. 2B. For this purpose, a gas inlet having a plurality of gas ejection holes so that the gas is ejected in shower form, or an annular gas inlet having an open hole portion which is capable of covering the entire upper surface of the laminated body, for example, is preferably used. Alternatively, the oxygen gas may simply be introduced into the deposition chamber through a gas pipe having a single inlet such that the gas is ejected onto the upper surface of the laminated body.

The substrate temperature during the exposure process is not particularly limited and does not influence the effects of the present invention as long as it is within a range extending from the temperature of the room in which the laminated body is created to approximately 300° C. The oxygen-containing gas used in the exposure process must have a high level of purity and be as free of impurities and moisture as possible so that a high quality recording medium can be created. In consideration of these points, the impurity concentration of the gas is preferably no more than 10 ppb, and the moisture concentration is preferably no more than 100 ppb.

When this exposure process to an oxygen-containing gas is performed, an improvement of approximately 200 to 300 Oe in the value of the anisotropic magnetic field (Hk) of soft magnetic underlayer 14 can be achieved in comparison with a case in which the process is not performed, and moreover, an improvement of approximately 2 dB can be achieved in the value of the signal-to-noise ratio (SNR).

Note that 100% pure oxygen gas is preferably employed as the gas used in this process, but as long as the gas contains at least 2 at % oxygen, sufficient improvements in the Hk and SNR can be expected.

Next, as shown in FIG. 2C, soft magnetic upper underlayer 14c is laminated onto non-magnetic metal layer 14b. Similarly to soft magnetic lower underlayer 14a, the lamination process may employ DC magnetron sputtering, RF magnetron sputtering, and vacuum deposition, for example. As a result of this series of laminations, soft magnetic underlayer 14 shown in FIG. 2C is obtained.

Non-Magnetic Intermediate Layer Formation Process

As shown in FIG. 2D, non-magnetic intermediate layer 16 is laminated onto soft magnetic upper underlayer 14c of soft magnetic underlayer 14. The lamination process may employ various deposition methods such as DC magnetron sputtering, RF magnetron sputtering, and vacuum deposition, for example. In consideration of evenness and deposition speed, magnetron sputtering is particularly preferable. When magnetron sputtering is used, direct current discharge is preferable as the sputtering condition due to its controllability. Further, non-magnetic intermediate layer 16 does not have to be a single layer, and may have a multi-layer structure comprising so-called seed layers.

Perpendicular Magnetic Recording Layer Formation Process

As shown in FIG. 2E, perpendicular magnetic recording layer 18 is laminated onto the non-magnetic intermediate layer 16. Various deposition methods such as DC magnetron sputtering, RF magnetron sputtering, and vacuum deposition, for example, may be used in the lamination process. In consideration of evenness and deposition speed, magnetron sputtering is particularly preferable. When magnetron sputtering is used, direct current discharge is preferable as the sputtering condition due to its controllability.

Protective Layer Formation Process

As shown in FIG. 2F, protective layer 20 is laminated onto perpendicular magnetic recording layer 18. The lamination process may employ various deposition methods such as DC magnetron sputtering, RF magnetron sputtering, and vacuum deposition, for example. When a carbon film is formed using CVD, a particularly fine and hard film can be obtained, which is preferable in terms of improving head flotation and environmental resistance.

Liquid Lubrication Layer Formation Process

As shown in FIG. 2G, liquid lubrication layer 22 is laminated onto protective layer 20. The lamination process may employ various deposition methods such as dipping and spin coating, for example. In consideration of the evenness of the liquid lubrication layer and the ease with which the film thickness thereof can be controlled, a spin coating method is preferably employed.

The manufacturing method for a magnetic recording medium according to the present invention, including each of the processes described above, does not employ the layer configuration of a conventional manufacturing method for a perpendicular magnetic recording medium, i.e., a layer configuration in which soft magnetic layers and non-magnetic layers constituting the soft magnetic underlayer are laminated together excessively. Instead, in the manufacturing method of the present invention, a simple layer configuration in which soft magnetic underlayer 14 comprises only soft magnetic lower underlayer 14a, non-magnetic metal layer 14b, and soft magnetic upper underlayer 14c is employed, as shown in FIG. 1. Further, the manufacturing method for a magnetic recording medium according to the present invention does not employ the complicated and excessive processing that accompanies the layer configuration used in a conventional manufacturing method for a perpendicular magnetic recording medium. Instead, in the manufacturing method of the present invention, simple processing whereby non-magnetic metal layer 14b of soft magnetic underlayer 14 is exposed to a gas containing oxygen is employed. Nevertheless, with the manufacturing method of the present invention, improvements in the anisotropic magnetic field (Hk) of the soft magnetic underlayer and the signal-to-noise ratio (SNR) of the magnetic recording medium can be achieved. Accordingly, the present invention is capable of providing a magnetic recording medium of far higher quality than those of the related art by means of a simple and inexpensive method.

### EXAMPLES

The effects of the present invention will be substantiated below using examples of the present invention.

Laminated Body Formation

### First Example

Perpendicular magnetic recording medium 10 shown in FIG. 1 was created in the following manner.

First, a disk-shaped, chemically strengthened glass substrate having a smooth surface (N-10 glass, manufactured by HOYA Ltd.), serving as non-magnetic substrate 12, was washed. Next, substrate 12 was introduced into a sputtering apparatus, and using a target containing 85% Co, 10% Zr, and 5% Nb, CoZrNb soft magnetic lower underlayer 14a was deposited on substrate 12 at 110 nm using a DC magnetron sputtering method in an atmosphere with an Ar gas pressure of 5 mtorr.

Next, Ru was deposited as non-magnetic metal layer 14b on soft magnetic lower underlayer 14a at 0.8 nm using a DC magnetron sputtering method in an atmosphere with an Ar gas pressure of 5 mtorr. The surface of non-magnetic metal layer 14b deposited in this manner was then exposed to Ar gas containing 2 at % oxygen gas for three seconds in an atmosphere of 5 mtorr.

Then, using the same target as that of soft magnetic lower underlayer 14a again, CoZrNb soft magnetic upper underlayer 14c was deposited at 90 nm on non-magnetic metal layer 14b using a DC magnetron sputtering method in an atmosphere with an Ar gas pressure of 5 mTorr, and thus soft magnetic underlayer 14 was obtained.

Next, using a carbon target, protective layer 20 made of carbon was deposited at 10 nm on soft magnetic underlayer 14 without depositing non-magnetic intermediate layer 16 and perpendicular magnetic recording layer 18, whereupon a laminated body comprising substrate 12, soft magnetic underlayer 14, and protective layer 20 was removed from the vacuum apparatus.

Next, liquid lubrication layer 22, constituted by perfluoropolyether, was formed at 1.5 nm using a spin coating method, and thus a laminated body not having perpendicular magnetic recording layer 18 was obtained.

Note that the film thickness of non-magnetic metal layer 14b was selected such that the Hk of soft magnetic underlayer 14 reached a maximum. Further, to verify the increase or decrease in Hk according to the application of the oxygen exposure process, the film thickness condition of non-magnetic metal layer 14b was set at an identical value, i.e., 0.8 nm, in the first example and all of the examples and comparative examples to be described below.

### Second Example

In the oxygen exposure process of non-magnetic metal layer 14b, the surface of non-magnetic metal layer 14b was exposed to Ar gas containing 10 at % oxygen gas for three seconds in an atmosphere of 5 mtorr. Otherwise, the laminated body was obtained in a similar manner to the first example.

### Third Example

In the oxygen exposure process of non-magnetic metal layer 14b, the surface of non-magnetic metal layer 14b was exposed to Ar gas containing 50 at % oxygen gas for three seconds in an atmosphere of 5 mtorr. Otherwise, the laminated body was obtained in a similar manner to the first example.

### Fourth Example

In the oxygen exposure process of non-magnetic metal layer 14b, the surface of non-magnetic metal layer 14b was exposed to 100 at % oxygen gas for three seconds in an atmosphere of 5 mtorr. Otherwise, the laminated body was obtained in a similar manner to the first example.

### Fifth Example

In the oxygen exposure process of non-magnetic metal layer 14b, the surface of non-magnetic metal layer 14b was exposed to Ar gas containing 2 at % oxygen gas for ten seconds in an atmosphere of 5 mtorr. Otherwise, the laminated body was obtained in a similar manner to the first example.

### First Comparative Example

The oxygen exposure process was not employed. Otherwise, a conventional laminated body not having a magnetic recording layer was obtained in a similar manner to the first example.

Evaluation of Anisotropic Magnetic Field (Hk)

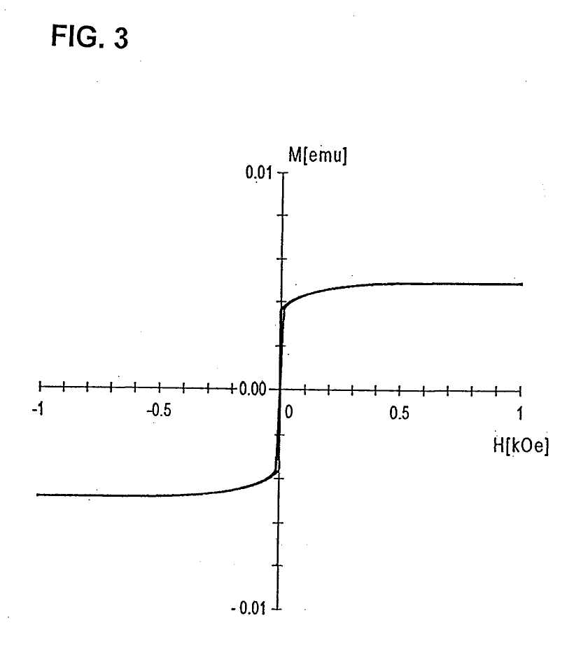

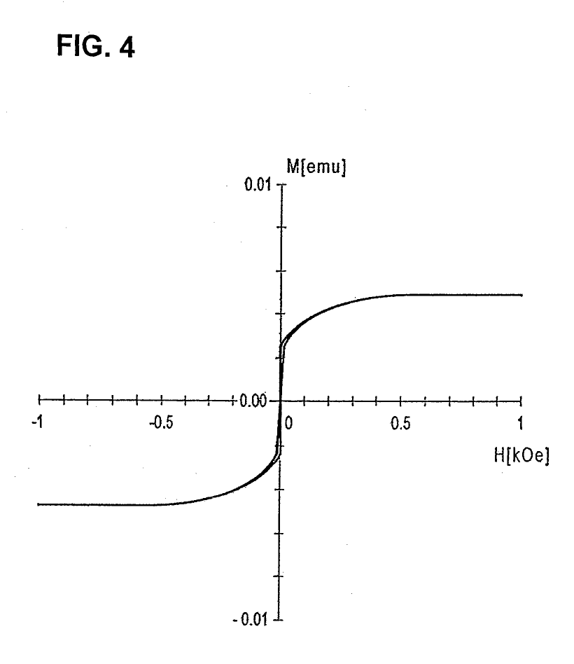

Hysteresis loops of the laminated bodies of the first example and first comparative example in the hard magnetization axis direction (radial direction) thereof were measured using a vibration sample magnetometer (VSM). The results are shown in FIG. 3 (first example) and FIG. 4 (first comparative example). In these hard magnetization axis direction hysteresis loops, the anisotropic magnetic field (Hk) of soft magnetic underlayer 14 is determined as the value (Os) of an applied magnetic field when magnetization is saturated. Note that in FIGS. 3 and 4, the ordinate shows the magnetization M (emu) and the abscissa shows the applied magnetic field H [kOe].

From FIG. 3, the Hk of soft magnetic underlayer 14 in the laminated body of the first example, in which the surface of non-magnetic metal layer 14b was exposed to Ar gas containing 2 at % oxygen gas for three seconds in an atmosphere of 5 mtorr, is determined at 662 Oe. From FIG. 4, the Hk of soft magnetic underlayer 14 in the laminated body of the first comparative example, in which the oxygen exposure process was not performed, is determined at 398 Oe. Hence, the determined Hk of the first example is approximately 1.7 times larger than the determined Hk of the first comparative example, and therefore the merits of employing the oxygen exposure process are verified. Note that the first example is particularly meritorious in that an improvement in Hk over that of the first comparative example can be achieved without employing a special layer configuration and without the need for complicated and expensive processing.

The Hk of soft magnetic underlayer 14 in the first to fifth examples and first comparative example, each having different oxygen exposure process conditions as described above, are shown in Table 1.

TABLE 1

| | Oxygen | Exposure | Anisotropic |
|---|---|---|---|
| | Concentration Of | Time | Magnetic |
| | Exposure Gas (At %) | (Seconds) | Field (Hk) (Oe) |
| First Example | 2 | 3 | 662 |
| Second Example | 10 | 3 | 683 |
| Third Example | 50 | 3 | 721 |
| Fourth Example | 100 | 3 | 768 |
| Fifth Example | 2 | 10 | 704 |
| First Comparative | 0 | — | 398 |
| Example | | | |

It can be seen from Table 1 that when the exposure time to the oxygen-containing gas is kept constant and the oxygen concentration thereof is increased, the Hk of soft magnetic underlayer 14 improves (first comparative example, first to fourth examples), and it can be seen that in the fourth example, the Hk is approximately 1.9 times that of the first comparative example.

It can also be seen that when the oxygen concentration of the exposure gas is kept constant and the exposure time is increased, the Hk of soft magnetic underlayer 14 increases (first, fifth examples), and it can be seen that in the fifth example, the Hk is approximately 1.1 times that of the first comparative example.

From the above, it may be said that as the total amount of oxygen in the oxygen-containing gas to which the surface of non-magnetic metal layer 14b is exposed increases, the Hk of soft magnetic underlayer 14 increases.

While not wishing to be bound by theory, the reason why it is possible to increase the Hk of soft magnetic underlayer 14 by subjecting non-magnetic metal layer 14b to oxygen exposure processing in this manner is believed to be as follows. In soft magnetic underlayer 14, an RKKY (Ruderman-Kittel-Kasuya-Yoshida) interaction occurs between soft magnetic upper and lower layers 14a, 14c when non-magnetic metal layer 14b is sandwiched between soft magnetic lower underlayer 14a and soft magnetic upper underlayer 14c shown in FIG. 1. This interaction is usually expressed as an exchange interaction coefficient (J_{EX}), and serves as an index that indicates the strength of the exchange coupling force acting between the upper and lower magnetic layers sandwiching the non-magnetic metal layer. Hence, by increasing the J_{EX}, the Hk of soft magnetic underlayer 14 increases.

The J_{EX} greatly affects the state of the interface between non-magnetic metal layer 14b and soft magnetic upper underlayer 14c formed thereon. More specifically, when the surface of non-magnetic metal layer 14b is subjected to oxygen exposure processing, the wettability and surface energy thereof increase. Under these conditions, a magnetic element can be coupled evenly onto non-magnetic metal layer 14b, and therefore the J_{EX} between non-magnetic metal layer 14b and soft magnetic upper underlayer 14c increases, leading to an increase in the Hk.

Note that in order to obtain sufficient Hk, the non-magnetic metal layer film thickness is important, and therefore the film thickness of non-magnetic metal layer 14b positioned between soft magnetic upper and lower layers 14a, 14c must be set at approximately 0.7 nm, i.e., to a level of several atomic layers.

Formation of Magnetic Recording Medium

Next, following the method described above in the first to fifth examples and first comparative example, non-magnetic substrate 12 and soft magnetic underlayer 14 shown in FIG. 1 were deposited. Next, non-magnetic intermediate layer 16, magnetic recording layer 18, protective layer 20, and liquid lubrication layer 22 shown in FIG. 1 were deposited in the manner described below, whereby the following magnetic recording media were obtained.

### Sixth Example

Using Ru as a target, Ru was deposited on soft magnetic underlayer 14 created in the first example at 20 nm using a DC magnetron sputtering method in an atmosphere with an Ar gas pressure of 20 mtorr, whereby non-magnetic intermediate layer 16 was obtained.

Next, using a multi-component target constituted by a 90 mol % (85% Co to 15% Pt) target and a 10 mol % SiO₂ target, perpendicular magnetic recording layer 18, taking a granular form having an added oxide, was deposited on non-magnetic intermediate layer 16 at 10 nm using an RF magnetron sputtering method in an atmosphere with an Ar gas pressure of 5 mtorr.

Next, using a carbon target, protective layer 20 made of carbon was deposited on perpendicular magnetic recording layer 18 at 10 nm, whereupon the structure was removed from the vacuum apparatus. Liquid lubrication layer 22 made of perfluoropolyether was then applied at 1.5 nm using a dipping method, whereby magnetic recording medium 10 was obtained.

### Seventh Example

Soft magnetic underlayer 14 was deposited in accordance with the method described in the second example. Otherwise, magnetic recording medium 10 was obtained in a similar manner to the sixth example.

### Eighth Example

Soft magnetic underlayer 14 was deposited in accordance with the method described in the third example. Otherwise, magnetic recording medium 10 was obtained in a similar manner to the sixth example.

### Ninth Example

Soft magnetic underlayer 14 was deposited in accordance with the method described in the fourth example. Otherwise, magnetic recording medium 10 was obtained in a similar manner to the sixth example.

### Tenth Example

Soft magnetic underlayer 14 was deposited in accordance with the method described in the fifth example. Otherwise, magnetic recording medium 10 was obtained in a similar manner to the sixth example.

### Second Comparative Example

Soft magnetic underlayer 14 was deposited in accordance with the method described in the first comparative example. Otherwise, magnetic recording medium 10 was obtained in a similar manner to the sixth example.

Evaluation of Electromagnetic Conversion Characteristic (SNR)

The electromagnetic conversion characteristic was evaluated in relation to the magnetic recording media of each of the sixth to tenth examples and second comparative example, obtained in the manner described above. More specifically, an evaluation of the signal-to-noise ratio (SNR) was performed using a spin stand tester and a single-pole-type head (write track width 0.25 μm) for perpendicular magnetic recording. The results are shown in Table 2. Note that the evaluated SNR values are measurement values at 336 kFCI (kilo Flux Change per Inch).

TABLE 2

| | Anisotropic Magnetic Field | Signal-To-Noise Ratio |
|---|---|---|
| | (Oe) | (Db) |
| Sixth Example | 662 | 26.6 |
| Seventh Example | 683 | 26.7 |
| Eighth Example | 721 | 27.3 |
| Ninth Example | 768 | 27.5 |
| Tenth Example | 704 | 27.1 |
| Second Comparative | 398 | 25.3 |
| Example | | |

According to Table 2, in the second comparative example, in which oxygen exposure is not performed, the SNR is 25.3 dB, whereas in all of the sixth to tenth examples, in which oxygen exposure is performed, the SNR is improved. In the ninth example, which has the greatest anisotropic magnetic field (Hk) value, the SNR takes a particularly favorable value of 27.5 dB, i.e., approximately 2.2 dB higher than that of the second comparative example.

According to the above, with the laminated body (first to fifth examples) and magnetic recording medium (sixth to ninth examples) of the present invention, an improvement in the Hk of the soft magnetic underlayer, which is effective in improving the recording and reproduction characteristics of a perpendicular recording medium, is achieved. Hence, simultaneously in each example, the exchange coupling magnetic field is improved, spike noise generated in the soft magnetic underlayer is suppressed, and the SNR of the magnetic recording medium is improved. Note that in the first through fifth examples and first comparative example, the Hk was evaluated in a state where non-magnetic intermediate layer 16 and magnetic recording layer 18 were not deposited, but this evaluation relates only to soft magnetic underlayer 14, and therefore the evaluation relating to the Hk of the first to fifth examples and first comparative example may be applied as is to the respective magnetic recording media of the sixth to tenth examples and second comparative example.

According to the present invention, the anisotropic magnetic field (Hk) of a soft magnetic underlayer can be improved without employing a special layer configuration and without the need for complicated and expensive processing, and at the same time, the exchange coupling magnetic field can also be improved. As a result, spike noise generated in the soft magnetic underlayer can be suppressed greatly, and the signal-to-noise ratio (SNR) of the magnetic recording medium can be improved. Hence, the present invention is able to provide a perpendicular magnetic recording medium that can be installed in various magnetic disk apparatuses from which a high level of recording density has been demanded in recent years.

Thus, a manufacturing method for a perpendicular magnetic recording medium has been described according to the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. A manufacturing method for a magnetic recording medium, comprising:
forming a soft magnetic underlayer by laminating a soft magnetic lower underlayer, a non-magnetic metal layer, and a soft magnetic upper underlayer in succession on a non-magnetic substrate, and
forming a perpendicular magnetic recording layer on said soft magnetic underlayer,
wherein, after forming said non-magnetic metal layer, its surface is exposed to a gas containing between 2 and 100 at % oxygen.

2. The manufacturing method for a magnetic recording medium according to claim 1, wherein a film thickness of said soft magnetic lower underlayer is between 10 and 500 nm, a film thickness of said non-magnetic metal layer is between 0.1 and 5 nm, and a film thickness of said soft magnetic upper underlayer is between 10 and 500 nm.

3. The manufacturing method for a magnetic recording medium according to claim 1, wherein said non-magnetic metal layer is formed from an element selected from Cu, Ru, Rh, Pd, and Re, or an alloy containing said elements, or a material having said elements or an alloy thereof as a main constituent.

4. The manufacturing method for a magnetic recording medium according to claim 1, further comprising forming a non-magnetic intermediate layer on said soft magnetic underlayer.

5. The manufacturing method for a magnetic recording medium according to claim 1, further comprising forming a protective layer on said perpendicular magnetic recording layer.

6. The manufacturing method for a magnetic recording medium according to claim 2, wherein said non-magnetic metal layer is formed from an element selected from Cu, Ru, Rh, Pd, and Re, or an alloy containing said elements, or a material having said elements or an alloy thereof as a main constituent.

7. The manufacturing method for a magnetic recording medium according to claim 2, further comprising forming a non-magnetic intermediate layer on said soft magnetic underlayer.

8. The manufacturing method for a magnetic recording medium according to claim 3, further comprising forming a non-magnetic intermediate layer on said soft magnetic underlayer.
